(19) United States
(12) Patent Application Publication
(10) Pub. No.: US 2026/0292843 A1
(43) Pub. Date: Sep. 24, 2026

(54) COMMUNICATION METHOD, TERMINAL, AND NETWORK-SIDE DEVICE

(71) Applicant: VIVO MOBILE COMMUNICATION CO., LTD., Dongguan (CN)

(72) Inventors: Zhipeng LIN, Dongguan (CN); Chengrui WANG, Dongguan (CN); Wei BAO, Dongguan (CN)

(73) Assignee: VIVO MOBILE COMMUNICATION CO., LTD., Dongguan (CN)

(21) Appl. No.: 19/685,696

(22) Filed: May 22, 2026

Related U.S. Application Data
(63) Continuation of application No. PCT/CN2024/133284, filed on Nov. 20, 2024.

(30) Foreign Application Priority Data
Nov. 22, 2023 (CN) 202311567147.4

(51) Int. Cl. H04W 72/232; H04W 24/04; H04W 72/044; H04W 72/542

(52) U.S. Cl. CPC H04W 72/232; H04W 24/04; H04W 72/044; H04W 72/542

(57) ABSTRACT

The present application discloses a communication method, a terminal, and a network-side device. The communication method in embodiments of the present application includes: a terminal sends, to a network-side device, an activation signal or a deactivation signal, the activation signal being used to request or notify the network-side device to activate a flexible resource for signal transmission, and the deactivation signal being used to request or notify the network-side device to deactivate the flexible resource.

### CROSS-REFERENCE TO RELATED APPLICATIONS

This application is a U.S. Continuation Application of International Application No. PCT/CN2024/133284, filed on Nov. 20, 2024, which claims priority to Chinese Patent Application No. 202311567147.4, entitled “COMMUNICATION METHOD, TERMINAL, AND NETWORK-SIDE DEVICE” filed with the China National Intellectual Property Administration on Nov. 22, 2023, both of which are incorporated herein by reference in their entireties for all purposes.

### TECHNICAL FIELD

This application relates to the field of communication technologies, and in particular, to a communication method, a terminal, and a network-side device.

### BACKGROUND

In a wireless communication system, a flexible resource may be configured, which is activated for signal transmission when required and deactivated when not required. In a deactivated state, a device does not need to perform signal detection on the flexible resource. In a case that the flexible resource is configured, how to further control the complexity and power consumption of signal detection is an urgent problem to be solved.

### SUMMARY

In a first aspect, a communication method is provided, which is performed by a terminal. The method includes:
transmitting, by a terminal, an activation signal or a deactivation signal to a network-side device. The activation signal is used for requesting or notifying the network-side device to activate a flexible resource for signal transmission. The deactivation signal is used for requesting or notifying the network-side device to deactivate the flexible resource.

In a second aspect, a communication method is provided, which is performed by a network-side device. The method includes:
receiving, by a network-side device, an activation signal or a deactivation signal from a terminal. The activation signal is used for requesting or notifying the network-side device to activate a flexible resource for signal transmission. The deactivation signal is used for requesting or notifying the network-side device to deactivate the flexible resource.

In a third aspect, a communication apparatus is provided, including:
a transmitting module, configured to transmit an activation signal or a deactivation signal to a network-side device. The activation signal is used for requesting or notifying the network-side device to activate a flexible resource for signal transmission. The deactivation signal is used for requesting or notifying the network-side device to deactivate the flexible resource.

In a fourth aspect, a communication apparatus is provided, including:
a receiving module, configured to receive an activation signal or a deactivation signal from a terminal. The activation signal is used for requesting or notifying the network-side device to activate a flexible resource for signal transmission. The deactivation signal is used for requesting or notifying the network-side device to deactivate the flexible resource.

In a fifth aspect, a terminal is provided. The terminal includes a processor and a memory. The memory stores a program or instructions executable in the processor. The program or instructions, when executed by the processor, implement the steps of the method described in the first aspect.

In a sixth aspect, a terminal is provided, including a processor and a communication interface. The processor is configured to determine an activation signal or a deactivation signal. The communication interface is configured to transmit the activation signal or the deactivation signal to a network-side device. The activation signal is used for requesting or notifying the network-side device to activate a flexible resource for signal transmission. The deactivation signal is used for requesting or notifying the network-side device to deactivate the flexible resource.

In a seventh aspect, a network-side device is provided. The network-side device includes a processor and a memory. The memory stores a program or instructions executable in the processor. The program or instructions, when executed by the processor, implement the steps of the method described in the second aspect.

In an eighth aspect, a network-side device is provided, including a processor and a communication interface. The communication interface is configured to receive an activation signal or a deactivation signal from a terminal. The activation signal is used for requesting or notifying the network-side device to activate a flexible resource for signal transmission. The deactivation signal is used for requesting or notifying the network-side device to deactivate the flexible resource. The processor is configured to process the activation signal or the deactivation signal.

In a ninth aspect, a readable storage medium is provided. The readable storage medium has a program or instructions stored therein. The program or instructions, when executed by a processor, implement the steps of the method described in the first aspect, or implements the steps of the method described in the second aspect.

In a tenth aspect, a wireless communication system is provided, including a terminal and a network-side device. The terminal may be configured to perform the steps of the method described in the first aspect. The network-side device may be configured to perform the steps of the method described in the second aspect.

In an eleventh aspect, a chip is provided. The chip includes a processor and a communication interface. The communication interface is coupled to the processor. The processor is configured to execute a program or instructions, to implement the method described in the first aspect or implement the method described in the second aspect.

In a twelfth aspect, a computer program/program product is provided. The computer program/program product is stored in a storage medium. The computer program/program product is executed by at least one processor, to implement the steps of the communication method described in the first aspect or implement the steps of the communication method described in the second aspect.

### BRIEF DESCRIPTION OF THE DRAWINGS

FIG. 1 is a block diagram of a wireless communication system to which embodiments of this application may be applied.

FIG. 2 is a schematic diagram of SSB-RO mapping.

FIG. 3 is another schematic diagram of SSB-RO mapping.

FIG. 4 is a schematic diagram of SSB-RO group mapping.

FIG. 5 is a schematic flowchart of a communication method according to an embodiment of this application.

FIG. 6 is a schematic flowchart of another communication method according to an embodiment of this application.

FIG. 7 is a schematic block diagram of a communication apparatus according to an embodiment of this application.

FIG. 8 is a schematic block diagram of another communication apparatus according to an embodiment of this application.

FIG. 9 is a schematic block diagram of a communication device according to an embodiment of this application.

FIG. 10 is a schematic structural diagram of a terminal according to an embodiment of this application.

FIG. 11 is a schematic structural diagram of a network-side device according to an embodiment of this application.

### DETAILED DESCRIPTION

Technical solutions in embodiments of this application are clearly described in the following with reference to the accompanying drawings in the embodiments of this application. Apparently, the described embodiments are some rather than all of the embodiments of this application. All other embodiments obtained by a person of ordinary skill in the art based on embodiments of this application fall within the protection scope of this application.

In this application, the terms “first” and “second” are used for distinguishing similar objects, but are not used for describing a specific sequence or order. It should be understood that terms used in this way are interchangeable in appropriate circumstances, so that embodiments of this application can be implemented in other orders than the order illustrated or described herein. In addition, objects distinguished by “first” and “second” are usually objects of one class with the number of objects unlimited. For example, a first object may indicate one or more first objects. In addition, “or” in this application indicates at least one of connected objects. For example, “A or B” covers three solutions: solution 1: including A and excluding B; solution 2: B is included and A is excluded; and solution 3: both A and B are included. The character “/” generally indicates an “or” relationship between the associated objects.

The term “indication” in this application may be either a direct indication (or an explicit indication) or an indirect indication (or an implicit indication). The direct indication may be understood as that a transmitting party explicitly notifies a receiving party of content such as specific information, an operation that needs to be performed, or a request result in the transmitted indication. The indirect indication may be understood as that the receiving party determines corresponding information based on an indication transmitted by the transmitting party, or performs determining and determines an operation that needs to be performed or a request result based on a determining result.

It should be noted that the technology described in the embodiments of this application is not limited to a long term evolution (Long Term Evolution, LTE)/LTE-advanced (LTE-Advanced, LTE-A) system, and may alternatively be used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency-Division Multiple Access, SC-FDMA), or another system. The terms “system” and “network” in the embodiments of this application are often used interchangeably, and the described technology may be applied to the systems and radio technologies mentioned above, and may alternatively be applied to other systems and radio technologies. The following description describes a new radio (New Radio, NR) system for illustration, and NR terminology is used in most of the following descriptions. However, these technologies may alternatively be applied to systems other than the NR system, such as 6^{th} generation (6^{th} Generation, 6G) communication systems.

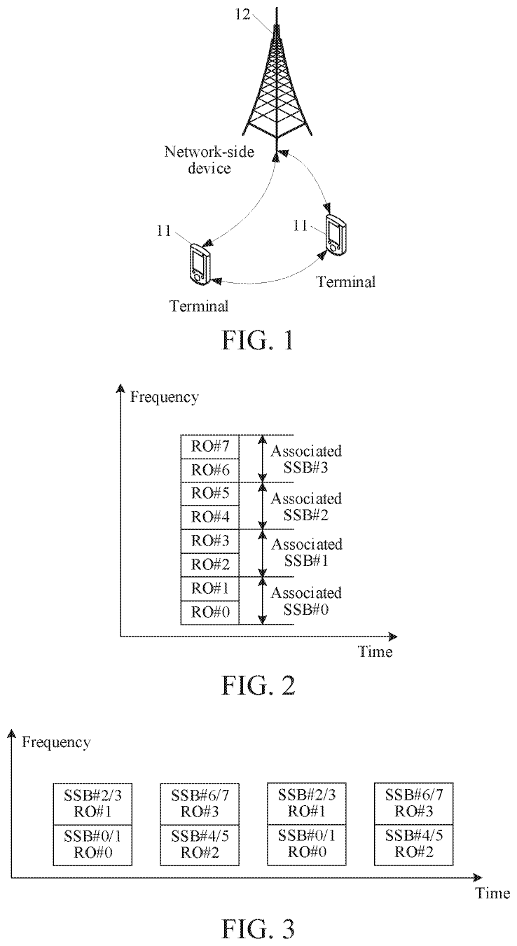

FIG. 1 shows a block diagram of a wireless communication system to which embodiments of this application may be applied. The wireless communication system includes a terminal 11 and a network-side device 12. The terminal 11 may be a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR), a virtual reality (Virtual Reality, VR) device, a robot, a wearable device (Wearable Device), a flight vehicle (flight vehicle), vehicle user equipment (Vehicle User Equipment, VUE), a shipborne device, pedestrian user equipment (Pedestrian User Equipment, PUE), a smart home appliance (home equipment with a wireless communication function, such as a refrigerator, a TV, a washing machine, or furniture), and a terminal side device such as a game console, a personal computer (Personal Computer, PC), an automated teller machine, or a self-service machine. The wearable device includes: a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The vehicle user equipment may alternatively be referred to as a vehicle terminal, a vehicle controller, a vehicle module, a vehicle component, a vehicle chip, a vehicle unit, or the like. It should be noted that a specific type of the terminal 11 is not limited in the embodiments of this application. The network-side device 12 may include an access network device or a core network device. The access network device may alternatively be referred to as a radio access network (Radio Access Network, RAN) device, a radio access network function, or a radio access network element. The access network device may include a base station, a wireless local area network (Wireless Local Area Network, WLAN) access point (Access Point, AP), a wireless fidelity (Wireless Fidelity, WiFi) node, or the like. The base station may be referred to as a node B (Node B, NB), an evolved mode B (evolved Node B, eNB), the next generation Node B (the next generation Node B, gNB), a new radio node B (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home node B (home Node B, HNB), a home evolved node B (home evolved Node B), a transmission reception point (Transmission Reception Point, TRP) or some other suitable terms in the field as long as the same technical effect is achieved. The base station is not limited to a specific technical word. It should be noted that in the embodiments of this application, introduction is made only taking the base station in the NR system as an example, and the specific type of the base station is not limited.

First, SSB-RO mapping rules involved in this application are described.

A synchronization signal/physical broadcast channel block (SS/PBCH block, SSB) in 5G includes a primary synchronization signal (Primary Synchronization Signal, PSS), a secondary synchronization signal (Secondary Synchronization Signal, SSS), a physical broadcast channel (Physical Broadcast Signal, PBCH), and a de-modulation reference signal (De-modulation Reference Signal, DMRS). A wireless device (terminal) performs time-frequency domain synchronization with a base station by providing synchronization signals and broadcast signals/channels from a cell of the base station through a cell search process, and obtains frequency-domain and time-domain positions of time-frequency resources of the cell deployed by the base station, as well as a physical cell ID.

The terminal further receives a system information block (System Information Block, SIB) 1 by receiving an SSB, where SIB1 includes various parameters for initial access. Configuration parameters of physical random access channel (PRACH) resources and the SSB-RO mapping rules are configured in the system information block (SIB) 1. In an NR system, a cell may configure a plurality of frequency division multiplexing (FDM) transmission occasion (RO) resources at one time-domain position for PRACH transmission. At a time point, a number of ROs on which FDM may be performed may be {1, 2, 4, 8}, and the number is configured and determined by using a higher layer parameter msg1-FDM.

A random access preamble (Preamble) may only be transmitted on a time-domain resource configured by a parameter PRACHConfigurationIndex and on a frequency-domain resource configured by the parameter msg1-FDM. PRACH frequency-domain resources satisfy n_{RA}∈{0, 1, . . . , M−1}, where M is equal to the higher layer parameter msg1-FDM. During initial access, the PRACH frequency-domain resources are numbered in ascending order from the lowest-frequency RO resource in an initial active uplink bandwidth part (initial active uplink bandwidth part). Otherwise, the PRACH frequency-domain resources are numbered in ascending order from the lowest-frequency RO resource in an active uplink bandwidth part (active uplink bandwidth part). For example, in FIG. 2, the number of FDM ROs at one time point is 8 (msg1-FDM=8), and the RO resources are numbered sequentially as RO #0 to RO #7 in ascending order of frequency.

In the NR system, an association exists between ROs and actually transmitted SSBs. ROs are associated with SSBs in an order of first frequency domain (from low frequency to high frequency) and then time domain. One SSB may be associated with a plurality of consecutive ROs, or a plurality of SSBs may be associated with one RO (in this case, different SSBs correspond to different Preambles). This is configured by the network through a parameter ssb-perRACH-OccasionAndCB-PreamblesPerSSB.

ssb-perRACH-OccasionAndCB-PreamblesPerSSB CHOICE {
oneEighth
ENUMERATED{n4,n8,n12,n16,n20,n24,n28,n32,n36,n40,n44,n48,n52,n56,n60,n64},
oneFourth
ENUMERATED{n4,n8,n12,n16,n20,n24,n28,n32,n36,n40,n44,n48,n52,n56,n60,n64},
oneHalf
ENUMERATED{n4,n8,n12,n16,n20,n24,n28,n32,n36,n40,n44,n48,n52,n56,n60,n64},
one
ENUMERATED{n4,n8,n12,n16,n20,n24,n28,n32,n36,n40,n44,n48,n52,n56,n60,n64},

| | |
|---|---|
| two | ENUMERATED{n4,n8,n12,n16,n20,n24,n28,n32 }, |
| four | INTEGER(1..16), |
| eight | INTEGER(1..8), |
| sixteen | INTEGER(1..4), |

} OPTIONAL,--Need

For example, oneEighth indicates that one SSB is associated with eight consecutive ROs, and eight indicates that eight SSBs are associated with one RO. {n4, n8, n12, . . . } indicates a number of Preambles associated with each SSB on one RO. For example, the value n4 indicates that the number of Preambles associated with each SSB on one RO is 4, and n8 indicates that the number of Preambles associated with each SSB on one RO is 8.

Around of association of all SSBs with ROs forms one SSB-RO mapping cycle (SSB-RO mapping cycle). One SSB-RO association period (association period) may include one or more SSB-RO mapping cycles. One SSB-RO association pattern period (association pattern period) may include one or more SSB-RO association periods. The SSB-RO mapping is repeated cyclically with the association pattern period, and a maximum association pattern period is 160 ms.

Usually, a base station may transmit different SSBs by using different beams, where a number of SSBs is configured by using an ssb-PositionsInBurst parameter. For example, for FR2, a maximum number of SSBs is 64. Based on the strength of a received downlink beam SSB, the terminal selects an RO/RO-preamble combination associated with an SSB with good signal quality for Msg1 transmitting. In this way, the network may determine an SSB selected by the terminal according to the RO/RO-preamble combination of the received Preamble, and transmit Msg2 on a downlink beam corresponding to the SSB, so as to ensure receiving quality of a downlink signal.

Taking FIG. 2 as an example, a number of FDM ROs at one time point is 8, and a number of actually transmitted SSBs is 4, namely SSB #0, SSB #1, SSB #2, and SSB #3, where each SSB is associated with two ROs. If the terminal determines to transmit PRACH/Msg1 on an RO corresponding to SSB #0, the user equipment (UE) selects one RO from RO #0 and RO #1 for PRACH transmitting.

Taking FIG. 3 as an example, a number of FDM ROs at one time point is 2, and a number of actually transmitted SSBs is 8, namely SSB #0, SSB #1, . . . , SSB #7, where every two SSBs are associated with one RO. In FIG. 3, each square corresponds to one RO rather than an SSB, and the SSB marked in the square refers to an SSB or SSBs with which the RO is associated. When a plurality of SSBs share one RO, Preamble sets associated with the plurality of SSBs are different. To be specific, the same Preamble cannot belong to Preamble sets associated with different SSBs at the same time. Taking RO #0 in FIG. 3 as an example, RO #0 has a total of 60 Preambles, where preambles having an index of 0 to 29 are associated with SSB #0, and preambles having an index of 30 to 59 are associated with SSB #1.

Before transmitting a PRACH, the terminal first selects, according to reference signal receiving power (Reference Signal Receiving Power, RSRP) of a received beam (SSB), an SSB having an RSRP higher than a threshold. If a plurality of SSBs have RSRP higher than the threshold, the terminal may select any SSB having RSRP higher than the threshold. When no SSB has RSRP higher than the threshold, the terminal may select one SSB based on implementation.

Based on the configuration of a network (Network), the terminal may obtain a correspondence between an SSB and an RO. After the SSB is selected, an RO corresponding to the selected SSB is used as an RO for transmitting a PRACH/Preamble/Msg1. If the selected SSB is associated with a plurality of ROs, the terminal may select one of the ROs to transmit the PRACH/Preamble/Msg1. For example, in the example shown in FIG. 2, assuming that the terminal selects SSB #1, the terminal may select one of RO #2 and RO #3 for PRACH/Msg1 transmitting. In the example shown in FIG. 3, if the terminal selects SSB #1, the terminal may select an available RO (RO #0 or 4), nearest to the current time, associated with SSB #1 for PRACH/Msg1 transmitting. In the selected RO, the terminal selects one preamble from a preamble set associated with the selected SSB for PRACH transmitting. As shown in FIG. 3, one RO is associated with two SSBs. Then, in an available Preamble set associated with SSBs in one RO, the preambles are divided into two subsets, where each subset corresponds to one SSB. The terminal selects a preamble sequence from the preamble subset corresponding to the selected SSB for PRACH/Msg1 transmitting.

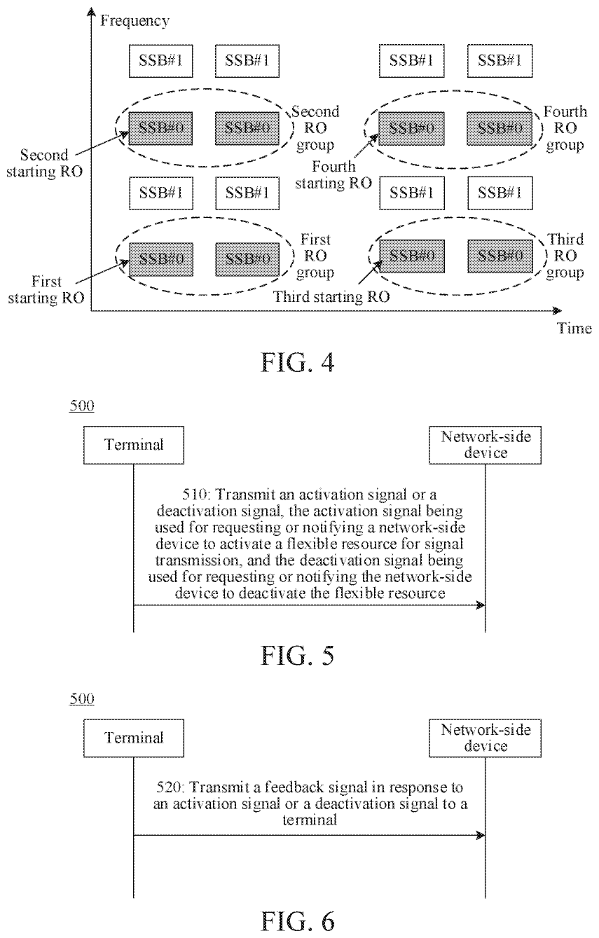

Next, a process for determining an RO set during repeated PRACH transmitting is described. Repeated PRACH transmitting is introduced in Rel-18 to enhance uplink coverage. For repeated PRACH transmitting, the terminal needs to repeatedly transmit the Preamble on a plurality of ROs at different time-domain positions associated with the same SSB, and a number of repetitions may be {2, 4, 8}. After determining the number of PRACH repetitions, the terminal needs to determine an RO set, where a number of valid ROs in the RO set is equal to the number of PRACH repetitions. Assuming that the number of PRACH repetitions is N1, an RO group (group) determining rule is as follows: first determining a starting RO (starting RO) of an RO group, and then determining the remaining N1−1 ROs of the RO group. The remaining N1−1 ROs of each RO group are ROs that are associated with the same SSB as the starting RO, at the same frequency position, and with the same associated Preamble set. For example, in FIG. 4, assuming that the number of PRACH repetitions is 2, for SSB #0, RO groups may be determined as follows: a 1^{st} RO group (1^{st} RO group), a 2^{st} RO group (2^{st} RO group), a 3^{st} RO group (3^{st} RO group), and a 4^{st} RO group (4^{st}RO group).

In a wireless communication system, a flexible resource may be configured, which is activated for signal transmission when required and deactivated when not required. In a deactivated state, a device does not need to perform signal detection on the flexible resource, thereby contributing to reducing the complexity and power consumption of signal detection. For example, a flexible PRACH resource may be configured. The flexible PRACH resource is activated when required. In this way, the network does not need to perform PRACH signal detection on the flexible PRACH resource in an inactive state. In a case that the flexible resource is configured, how to further control the complexity and power consumption of signal detection is an urgent problem to be solved.

Embodiments of this application provide a communication method, a terminal, and a network-side device. A terminal transmits an activation signal or a deactivation signal to a network-side device. The activation signal is used for requesting or notifying the network-side device to activate a flexible resource for signal transmission. The deactivation signal is used for requesting or notifying the network-side device to deactivate the flexible resource. Therefore, the embodiments of this application can enable the terminal to trigger activation or deactivation of the flexible resource, so that signal detection does not need to be performed on the flexible resource when the flexible resource is inactive, thereby contributing to reducing the complexity and power consumption of signal detection. Meanwhile, the flexible resource may further be used for scheduling other signal transmissions, thereby contributing to improving resource utilization.

The communication method according to the embodiments of this application is described in detail below through some embodiments and application scenarios thereof with reference to the accompanying drawings.

FIG. 5 shows a schematic interaction diagram of a communication method according to an embodiment of this application. As shown in FIG. 5, the communication method includes at least the following step 510:

510: A terminal transmits an activation signal or a deactivation signal to a network-side device. The activation signal is used for requesting or notifying the network-side device to activate a flexible resource for signal transmission. The deactivation signal is used for requesting or notifying the network-side device to deactivate the flexible resource. Correspondingly, the network-side device may receive the activation signal or the deactivation signal from the terminal.

By way of example, the flexible (flexible) resource in the embodiments of this application may be a resource that can be activated or deactivated, including at least one of a flexible time-frequency resource, a DMRS resource, or a sequence. As an example, the flexible resource may include, but is not limited to, at least one of a flexible PRACH transmission occasion (flexible PRACH transmission occasion, flexible RO), a flexible PUSCH transmission occasion (flexible PUSCH transmission occasion), a flexible paging occasion (flexible paging occasion), a flexible PDSCH transmission occasion (flexible PDSCH transmission occasion), a flexible PDCCH transmission occasion (flexible PDCCH transmission occasion), or a flexible MsgA PUSCH transmission occasion (flexible MsgA PUSCH transmission occasion).

By way of example, activating a flexible resource may mean allowing signals to be transmitted (or received) on the corresponding flexible resource. Deactivating a flexible resource may mean prohibiting signals from being transmitted (or received) on the corresponding flexible resource.

When the flexible (flexible) resource includes a flexible RO, activating the flexible RO may refer to activating part of preambles on the flexible RO or activating all preambles. This is not limited in this application. By way of example, activating a flexible RO means allowing the terminal to transmit a signal (e.g., PRACH, MsgA, or preamble) on the corresponding flexible RO, or allowing the network-side device to detect the signal (e.g., PRACH, MsgA, or preamble) on the corresponding flexible RO. Deactivating a flexible RO means prohibiting the terminal from transmitting a signal (e.g., PRACH, MsgA, or preamble) on the corresponding flexible RO, or prohibiting the network-side device from detecting the signal (e.g., PRACH, MsgA, or preamble) on the corresponding flexible RO.

It should be noted that activation in the embodiments of this application may refer to (notifying) activation of a flexible resource or requesting activation of a flexible resource, and may be briefly referred to as activation in some cases. Deactivation in the embodiments of this application may refer to (notifying) deactivation of a flexible resource or requesting deactivation of a flexible resource, and may be briefly referred to as deactivation in some cases. Correspondingly, the activation signal in the embodiments of this application may be a signal for (notifying) activation of a flexible resource or a signal for requesting activation of a flexible resource. The deactivation signal may be a signal for (notifying) deactivation of a flexible resource or a signal for requesting deactivation of a flexible resource.

By way of example, in the embodiments of this application, the signal transmitted on the flexible resource includes, but is not limited to, at least one of a PRACH, message A (MsgA), a MsgA physical uplink shared channel (Physical Uplink Shared Channel, PUSCH), a paging message, a PDSCH, or a PDCCH.

It should be noted that when an activation signal is used for requesting the network-side device to activate the flexible resource for signal transmission, the activation signal may alternatively be referred to as a request activation signal. When a deactivation signal is used for requesting the network-side device to deactivate the flexible resource for signal transmission, the deactivation signal may alternatively be referred to as a request deactivation signal. It may be understood that when the activation signal is used for requesting the network-side device to activate the flexible resource for signal transmission, flexible resource activation needs to be performed with the permission of the network-side device. When the deactivation signal is used for requesting the network-side device to deactivate the flexible resource for signal transmission, flexible resource deactivation needs to be performed with the permission of the network-side device.

Therefore, in the embodiments of this application, by transmitting the activation or deactivation signal to the network-side device, the terminal can trigger activation or deactivation of the flexible resource, so that the flexible resource is activated only when required and not activated (deactivated) when not required. Therefore, signal detection on the flexible resource is not required in a case that the flexible resource is inactive, thereby contributing to reducing the complexity and power consumption of signal detection. Meanwhile, the flexible resource may further be used for scheduling other uplink or downlink transmissions, thereby contributing to improving resource utilization.

For example, for a flexible RO, a network does not need to perform PRACH detection on the flexible RO in an inactive state, thereby contributing to reducing the complexity of PRACH detection by the network and the power consumption of the network. In addition, the flexible RO may be used for scheduling other uplink transmissions in an inactive state, thereby contributing to improving resource utilization.

In some embodiments, an activation signal or an activation signal resource may be associated with a reference signal. By way of example, the reference signal includes, but is not limited to, an SSB, a channel state information-reference signal (Channel State Information-Reference Signal, CSI-RS), a tracking reference signal (Tracking Reference Signal, TRS), message A (message A, MsgA), a MsgA PUSCH, a PRACH, a configured grant (configured grant, CG) PUSCH, and the like. By way of example, the association from the reference signal to the activation signal or the activation signal resource includes, but is not limited to, an association from an SSB to the activation signal or the activation signal resource, an association from a CSI-RS to the activation signal or the activation signal resource, an association from a TRS to the activation signal or the activation signal resource, an association from a PRACH resource to the activation signal or the activation signal resource, an association from a MsgA resource to the activation signal or the activation signal resource, an association from a MsgA PUSCH resource to the activation signal or the activation signal resource, and an association from a CG PUSCH to the activation signal or the activation signal resource.

The SSB in the embodiments of this application may alternatively be referred to as any module including at least one of a synchronization signal, a broadcast signal, a PBCH, or other system message downlink broadcast signals.

In some embodiments, a retransmission mechanism for the activation signal or the deactivation signal may be introduced to improve the reliability of the activation signal or the deactivation signal. In other words, in the embodiments of this application, the activation signal or the deactivation signal supports retransmission.

Optionally, the terminal retransmits the activation signal when a number of failed signal transmissions on the flexible resource exceeds or is not less than a first preset number.

For example, when the flexible resource is a flexible RO, if the number of failed PRACH transmissions on the flexible RO is greater than or not less than the first preset number, the transmission failure may be unsuccessful activation of the flexible RO. In this case, the terminal may transmit the activation signal to the network-side device again to activate the flexible RO. Optionally, the first preset number may be configured by the network-side device or specified by a protocol. This is not limited in this application.

Optionally, the terminal retransmits the deactivation signal when the terminal receives a response message for a signal transmitted on the flexible resource.

For example, when the terminal receives a random access response (Random access response, RAR) message corresponding to a PRACH on the flexible RO, the terminal may determine that the PRACH has been successfully transmitted. In this case, the terminal may transmit the deactivation signal to the network-side device again to deactivate the flexible RO.

In some embodiments, the terminal retransmits the activation signal within a first time window or before a first timer expires. Specifically, a transmitting time window (i.e., the first time window) for the activation signal or a timer (timer, namely the first timer) may be introduced. The terminal may retransmit the activation signal within the first time window or before the first timer expires. The terminal may stop transmitting the activation signal outside the first time window or when the first timer expires.

Optionally, the terminal retransmits the deactivation signal when the terminal receives a response message for a signal transmitted on the flexible resource and a number of receptions of the response message exceeds a second preset number.

For example, when the terminal receives an RAR message corresponding to a PRACH on the flexible RO and the number of receptions of the RAR message exceeds the second preset number, the terminal may determine that the PRACH has been successfully transmitted. In this case, the terminal may transmit the deactivation signal to the network-side device again to deactivate the flexible RO. Optionally, the second preset number may be configured by the network-side device or specified by a protocol. This is not limited in this application.

In some embodiments, the terminal retransmits the deactivation signal within a second time window or before a second timer expires. Specifically, a transmitting time window (i.e., the second time window) for the deactivation signal or a timer (i.e., the second timer) may be introduced. The terminal may retransmit the deactivation signal within the second time window or before the second timer expires. The terminal may stop transmitting the deactivation signal outside the second time window or when the second timer expires.

In some embodiments, a maximum number of retransmissions (i.e., a maximum number of repetitions) for the activation signal or the deactivation signal may be introduced. It is determined that the signal transmission fails when a maximum number of retransmissions of the activation signal or the deactivation signal is reached.

Optionally, the activation signal and the deactivation signal may correspond to the same maximum number of retransmissions or different maximum number of retransmissions respectively. This is not limited in this application. Optionally, the maximum number of retransmissions may be configured by the network-side device or specified by a protocol. This is not limited in this application.

By way of example, when the activation signal for requesting or notifying activation of the flexible RO reaches the maximum number of retransmissions, or the deactivation signal for requesting or notifying deactivation of the flexible RO reaches the maximum number of retransmissions, a random access failure may be determined (e.g., declared).

Therefore, in the embodiments of this application, by supporting retransmission of an activation signal or a deactivation signal, setting a maximum number of retransmissions and setting a transmitting time window or a timer, the reliability of transmission of the activation signal or the deactivation signal can be improved.

In some embodiments, referring to FIG. 6, the communication method 500 may further include the following step 520:

520: The network-side device transmits a feedback signal in response to the activation signal or the deactivation signal to the terminal. Correspondingly, the terminal receives the feedback signal from the network-side device. The feedback signal may be used for feeding back a receiving state or a response of the network-side device with respect to the activation signal or the deactivation signal.

In some embodiments, the feedback signal is used for indicating one or more of the following:
whether the activation signal or the deactivation signal is successfully received;
whether the network-side device activates or deactivates the flexible resource; or
time at which the network-side device activates or deactivates the flexible resource.

Therefore, in the embodiments of this application, the network-side device transmits a feedback signal in response to an activation signal or a deactivation signal to the terminal, so that the terminal may determine whether the activation signal or the deactivation signal is successfully received by the network-side device, or the terminal may determine whether the network-side device activates or deactivates a flexible resource, or determine time at which the network-side device activates or deactivates the flexible resource, thereby further improving the reliability of transmission of the activation signal or the deactivation signal.

In some embodiments, the feedback signal may include at least one of a specific reference signal, a response message, or physical layer signaling.

As an implementation, step 520 may be specifically implemented as follows: the network-side device transmits a specific reference signal to the terminal as the feedback signal. Correspondingly, the terminal receives the specific reference signal from the network-side device.

By way of example, the specific reference signal may include, but is not limited to, at least one of a specific SSB, a channel state information-reference signal (Channel State Information-Reference Signal, CSI-RS), a tracking reference signal (Tracking Reference Signal, TRS), or the like. Optionally, the reference signal may include a reference signal of one cell or reference signals of a plurality of cells. The cells may be on the same frequency carrier (frequency carrier) or different frequency carriers, and may be within the same band (band) or different bands. This is not limited herein.

Optionally, the specific reference signal may include first indication information, used for indicating whether the activation signal or the deactivation signal is successfully received, or indicating that the network-side device activates or deactivates the flexible resource, or indicating time at which the network-side device activates or deactivates the flexible resource. By including the first indication information in the specific reference signal, the network-side device can explicitly indicate to the terminal whether the activation signal or the deactivation signal is successfully received, or explicitly indicate whether to activate or deactivate the flexible resource, or explicitly indicate time at which the flexible resource is activated or deactivated.

By way of example, a specific bit (bit) in a master information block (Master Information Block, MIB) of a specific SSB, such as an intra-frequency reselection indication (Intra-freq reselection indication) bit, may be used as the first indication information, to indicate whether the activation signal or the deactivation signal corresponding to the flexible RO is successfully received, or indicate whether the network-side device activates or deactivates the flexible RO, or indicate time at which the network-side device activates or deactivates the flexible RO.

Optionally, the specific reference signal may include an on-demand (on-demand) reference signal. The on-demand reference signal is used for indicating that the activation signal is successfully received, or indicating that the network-side device activates the flexible resource, or indicating time at which the network-side device activates or deactivates the flexible resource.

By way of example, the feedback signal in response to the activation signal or the deactivation signal of the flexible RO is a corresponding on-demand SSB. Specifically, when the flexible RO is activated, the corresponding on-demand SSB is also activated. The terminal may determine whether the activation signal is received according to whether the on-demand SSB is received, or determine whether the network-side device activates the flexible RO, or determine time at which the network-side device activates the flexible RO. For example, after transmitting the activation signal, the terminal may determine that the activation signal is received according to reception of the on-demand SSB, or determine that the network-side device activates the flexible RO according to reception of the on-demand SSB, or determine time ((the time may be carried in the on-demand SSB)) at which the network side activates the flexible RO according to the received on-demand SSB.

Therefore, by including the on-demand reference signal in the specific reference signal, which is activated when the flexible resource is activated, the network-side device can indicate to the terminal whether the activation signal or the deactivation signal is successfully received, or indicate whether to activate or deactivate the flexible resource, or indicate time at which the flexible resource is activated or deactivated.

Optionally, the terminal determines that the deactivation signal is successfully received, or determines that the network-side device deactivates the flexible resource, when the terminal device does not receive the specific reference signal.

By way of example, when the flexible RO is deactivated, the corresponding on-demand SSB is also deactivated. The terminal may determine that the deactivation signal is received by the network-side device, or that the network-side device deactivates the flexible RO, according to failure to receive the on-demand SSB. For example, after the terminal determines that the network-side device activates the flexible RO according to reception of the on-demand SSB, the terminal transmits the deactivation signal to the network-side device. In this case, the terminal may determine that the deactivation signal is received, or that the network-side device deactivates the flexible RO, according to failure to receive the on-demand SSB.

Therefore, by including the on-demand reference signal in the specific reference signal, which is deactivated when the flexible resource is deactivated, the network-side device can implicitly indicate to the terminal that the deactivation signal is successfully received, or implicitly indicate that the flexible resource is activated or deactivated.

As another implementation, step 520 may be specifically implemented as follows: the network-side device transmits a response (response) message to the terminal as the feedback signal. Correspondingly, the terminal receives the response message from the network-side device.

Optionally, the response message may include second indication information, used for indicating whether the activation signal or the deactivation signal is successfully received, or indicating that the network-side device activates or deactivates the flexible resource, or indicating time at which the network-side device activates or deactivates the flexible resource. By including the second indication information in the response message, the network-side device can explicitly indicate to the terminal whether the activation signal or the deactivation signal is successfully received, or explicitly indicate whether to activate or deactivate the flexible resource, or explicitly indicate time at which the flexible resource is activated or deactivated.

In some embodiments, the terminal determines that the activation signal is successfully received, or determines that the network-side device activates the flexible resource, when the terminal identifies the response message according to a preset first radio network temporary identifier (Radio Network Temporary Identifier, RNTI). In some embodiments, the terminal determines that the deactivation signal is successfully received, or determines that the network-side device deactivates the flexible resource, when the terminal identifies the response message according to a preset second RNTI.

As an example, the first RNTI or the second RNTI may reuse an RNTI in the related art, such as a P-RNTI for detecting a paging message, or an RA-RNTI for detecting an RAR response. This is not limited in this application. As another example, the first RNTI is configured as an RNTI dedicated to detecting a response message to the activation signal, and the second RNTI is configured as an RNTI dedicated to detecting a response message to the deactivation signal. This is not limited in this application.

Therefore, in the embodiments of this application, by identifying the response message using the corresponding RNTI, the response message can indicate whether the activation signal or the deactivation signal is successfully received, or indicate that the flexible resource is activated or deactivated.

In some embodiments, step 520 may be specifically implemented as follows: the network-side device transmits physical layer signaling to the terminal as the feedback signal. Correspondingly, the terminal receives the physical layer signaling from the network-side device.

By way of example, the physical layer signaling may include, but is not limited to, a PDCCH order (order), downlink control information (DCI), and the like. This is not limited in this application.

Optionally, the terminal may receive a first physical downlink control channel (PDCCH) order from the network-side device. The first PDCCH order is used for indicating that the signal is transmitted using the flexible resource, or indicating that the network-side device activates the flexible resource, or indicate time at which the network-side device activates the flexible resource. Therefore, the network transmits the first PDCCH order to the terminal, so that the network-side device can explicitly indicate to the terminal that the activation signal is successfully received, or that the flexible resource is activated, or time at which the flexible resource is activated.

For example, after receiving the activation signal for activating the flexible RO, the network-side device may indicate, by using the first PDCCH order, to use a resource on the corresponding flexible RO for PRACH transmission, or indicate that the network-side device activates the resource on the flexible RO. Optionally, the first PDCCH order may indicate time at which the network-side device activates the flexible RO.

Optionally, the terminal may receive a second PDCCH order from the network-side device. The second PDCCH order is used for indicating that the signal is transmitted using a normal resource, or indicating that the network-side device deactivates the flexible resource, or indicate time at which the network-side device deactivates the flexible resource. Therefore, the network transmits the second PDCCH order to the terminal, so that the network-side device can explicitly indicate to the terminal that the deactivation signal is successfully received, or that the flexible resource is deactivated, or time at which the flexible resource is deactivated.

For example, after receiving the deactivation signal for deactivating the flexible RO, the network-side device may indicate, by using the second PDCCH order, to use a resource on a corresponding normal (normal) RO for PRACH transmission, or indicate that the network-side device deactivates the resource on the flexible RO. Optionally, the second PDCCH order may be used for indicating time at which the network-side device deactivates the flexible RO.

In some embodiments, the normal resource may alternatively be a static (static) resource, such as a static RO. This is not limited in this application.

Optionally, the terminal may receive a third PDCCH order from the network-side device. The third PDCCH order includes a first preamble (preamble) identifier ID. The first preamble ID is used for indicating that the activation signal is successfully received, or indicating that the network-side device activates the flexible resource.

Optionally, the terminal may receive a fourth PDCCH order from the network-side device. The fourth PDCCH order includes a second preamble ID. The second preamble ID is used for indicating that the deactivation signal is successfully received, or indicating that the network-side device deactivates the flexible resource.

By way of example, the network-side device may use a special PDCCH order, for example, configure a preamble ID in the PDCCH order as a special value, to notify the terminal whether the network receives the corresponding activation signal or deactivation signal, or to notify the terminal whether the network activates or deactivates the flexible resource. For example, the network-side device may configure the preamble ID in the third PDCCH order as a first value (i.e., corresponding to the first preamble ID), to indicate that the activation signal is successfully received, or indicate that the network-side device activates the flexible resource. For another example, the network-side device may configure the preamble ID in the fourth PDCCH order as a second value (i.e., corresponding to the second preamble ID), to indicate that the deactivation signal is successfully received, or indicate that the network-side device deactivates the flexible resource.

Therefore, the network transmits a special PDCCH order to the terminal, for example, configures a preamble ID in the PDCCH order as a special value, so that the network-side device can explicitly indicate to the terminal whether the activation signal is successfully received, or whether the flexible resource is activated.

Optionally, the terminal may receive a first common PDCCH from the network-side device. The first common PDCCH is of a first DCI format, for indicating that the activation signal is successfully received, or that the network-side device activates the flexible resource. Optionally, the terminal may receive a second common PDCCH from the network-side device. The second common PDCCH is of a second DCI format, for indicating that the deactivation signal is successfully received, or that the network-side device deactivates the flexible resource. By way of example, the common (common PDCCH) may include a common PDCCH dedicated to feeding back whether the activation signal or the deactivation signal is successfully received, or a common PDCCH for paging (paging), or another common PDCCH. This is not limited in this application.

Therefore, by transmitting a common (common) PDCCH order to the terminal, the network implicitly indicates to the terminal, through a specific DCI format (format), whether the activation signal is successfully received, or whether the flexible resource is activated.

In some embodiments, step 520 may be specifically implemented as follows: the terminal receives the feedback signal within a third time window.

Optionally, at least one of a starting position and a length of the third time window may be configured by the network-side device or specified by a protocol. This is not limited in this application.

Optionally, the third time window for the feedback signal corresponding to the activation signal or the third time window for the feedback signal corresponding to the deactivation signal may be configured separately or configured as the same time window. This is not limited in this application.

Optionally, the starting position of the third time window includes a first time for receiving a downlink signal after transmitting the activation signal or the deactivation signal. Optionally, the length of the third time window is N times a length of a random access response (RAR) window, N being a positive integer, where N is configured by the network-side device or specified by a protocol.

In some embodiments, the terminal retransmits the activation signal or the deactivation signal if the terminal does not receive the feedback signal within the third time window.

As a possible implementation, the terminal may retransmit the activation signal or the deactivation signal at a first time after the third time window expires. Optionally, the first time may be configured by the network-side device or specified by a protocol. This is not limited in this application.

Therefore, in the embodiments of this application, by setting a receiving window for the feedback signal in response to the activation signal or the deactivation signal, the reliability of transmission of the activation signal or the deactivation signal can be improved.

In some embodiments, in a case that the flexible resource and the normal resource are configured independently, or the flexible resource and the normal resource are configured by a common resource but the flexible resource and the normal resource are FDMs or spaced apart in time domain, after the flexible resource is activated, it is required to be considered under which conditions to select the flexible resource for signal transmission, or under which conditions to select the normal resource for signal transmission, so as to ensure that the terminal selects an appropriate RO, reduce conflicts with other terminals on PRACH resources, and improve a probability that the PRACH is successfully received.

In some embodiments, the terminal transmits the signal to the network-side device using the flexible resource when the terminal determines that the flexible resource has been activated. Optionally, when the flexible resource is not successfully activated or is deactivated, the terminal may transmit a signal to the network-side device using the normal resource. For example, when the terminal determines that a flexible RO is activated or takes effect, the terminal may preferentially select the activated flexible RO to transmit the PRACH. When the terminal determines that the flexible RO is not successfully activated or is successfully deactivated, the terminal may select a normal RO to transmit the PRACH.

In some embodiments, the terminal transmits the signal to the network-side device using the flexible resource within a preset time range. The preset time range may be configured by the network-side device or specified by a protocol. This is not limited in this application. Optionally, when the preset time range is exceeded, the terminal may transmit the signal to the network-side device using the normal resource.

For example, when the terminal determines that a flexible RO is activated or takes effect, the terminal preferentially selects the flexible RO to transmit the PRACH within the preset time range. By way of example, the preset time range may include at least one resource configuration cycle (e.g., a PRACH resource configuration cycle). For example, when the terminal determines that a flexible RO is activated or takes effect, the terminal preferentially selects the flexible RO to transmit the PRACH within one PRACH resource configuration cycle.

In some embodiments, the terminal transmits the signal using a first nearest available resource in a next time period when the terminal does not receive a response message to the signal transmitted on the flexible resource. For example, when the flexible RO is selected to transmit the PRACH and the terminal does not successfully receive the RAR, the terminal preferentially selects a first nearest available RO in a next time period for PRACH resource transmission when entering the next time period. The available RO may be a flexible RO or a normal RO. This is not limited in this application.

In some embodiments, the terminal transmits the signal to the network-side device using the flexible resource for initial transmission of the signal.

Optionally, the initial transmission includes at least one of the following:
initial transmission without power ramping (power ramping);
initial transmission including repetitions; or
initial transmission not including repetitions.

The initial transmission without power ramping refers to initial transmission performed using initial power.

During one signal transmission process, a plurality of repeated signal transmissions, i.e., repetitions (repetition), may be performed to ensure that the signal transmission can be successfully received by a peer device. The initial transmission including repetitions means that the initial transmission includes repetitions in a first signal transmission process. The initial transmission not including repetitions means that the initial transmission includes only a first signal transmission in the first signal transmission process.

Optionally, when only one signal transmission is performed in the initial signal transmission process, i.e., no repeated signal transmissions are performed in the initial signal transmission, the initial transmission refers to the first data transmission process including this signal transmission.

In some embodiments, the terminal transmits the signal to the network-side device using the flexible resource when a first measurement metric of a reference signal corresponding to the flexible resource satisfies a first preset condition. In other words, whether the terminal preferentially selects the flexible resource for signal transmission depends on the measurement metric of the reference signal associated with the flexible resource.

By way of example, the reference signal corresponding to (associated with) the flexible resource may include, but is not limited to, at least one of an SSB, a channel state information-reference signal (Channel State Information-Reference Signal, CSI-RS), or a tracking reference signal (Tracking Reference Signal, TRS).

Optionally, the first preset condition may include at least one of the following:
the first measurement metric is greater than or not less than a second measurement metric of a reference signal corresponding to a common time-frequency resource; or
the first measurement metric is greater than or not less than a preset threshold.

By way of example, the first measurement metric or the second measurement metric may include RSRP, reference signal receiving quality (Reference Signal Receiving Quality, RSRQ), or the like. This is not limited herein. For example, when the RSRP measured for the SSB as a reference signal associated with the flexible RO is greater than or not less than the RSRP measured for the SSB as a reference signal associated with the normal RO, the flexible RO is selected for PRACH transmission. Conversely, when the RSRP measured for the SSB as a reference signal associated with the flexible RO is less than the RSRP measured for the SSB as a reference signal associated with the normal RO, the normal RO may be selected for PRACH transmission.

For another example, when the RSRP of an SSB as a reference signal in a direction associated with the flexible RO, e.g., a specific SSB index (index), is greater than or not less than the RSRP of the same SSB index associated with the normal RO, the flexible RO is selected for PRACH transmission. Conversely, when the RSRP of an SSB as a reference signal in a direction associated with the flexible RO, e.g., a specific SSB index (index), is less than the RSRP of the same SSB index associated with the normal RO, the normal RO may be selected for PRACH transmission.

For another example, when the RARP measured for the SSB as a reference signal associated with the flexible RO is greater than or not less than a preset threshold, the flexible RO is selected for PRACH transmission. Conversely, when the RARP measured for the SSB as a reference signal associated with the flexible RO is less than the preset threshold, the normal RO may be selected for PRACH transmission.

For another example, when the RARP of an SSB as a reference signal in a direction associated with the flexible RO, e.g., a specific SSB index, is greater than or not less than the preset threshold, the flexible RO is selected for PRACH transmission. Conversely, when the RARP of an SSB as a reference signal in a direction associated with the flexible RO, e.g., a specific SSB index, is less than the preset threshold, the normal RO may be selected for PRACH transmission.

In some embodiments, the terminal transmits the signal to the network-side device using a normal resource switched from the flexible resource when a second preset condition is satisfied. In other words, the terminal supports switching from the flexible resource to the normal resource for signal transmission.

Optionally, the second preset condition includes at least one of the following:
a number of failed transmissions of the signal by the terminal on the flexible resource is greater than or not less than a preset threshold;
the measurement metric of the reference signal corresponding to the flexible resource does not meet preset requirements;
a number of repetitions of signal transmission by the terminal on the flexible resource is greater than or not less than a preset threshold; or
a number of retransmissions of the activation signal is greater than or not less than a preset threshold.

For example, when the flexible resource is a flexible RO, the terminal switches from the flexible RO to a normal RO for PRACH transmission if the number of failed transmissions on the flexible RO is greater than or not less than a preset value, such as a particular number. For another example, the terminal switches from the flexible RO to a normal RO for PRACH transmission if the terminal measures that the signal strength (e.g., RSRP) or quality (e.g., RSRQ) of a reference signal associated with the flexible RO, such as an SSB, or a function thereof, fails to meet a particular requirement. For another example, the terminal switches from the flexible RO to a normal RO for PRACH transmission after attempting for a maximum or particular number of PRACH repetitions on the flexible RO. For another example, the terminal switches from the flexible RO to a normal RO for PRACH transmission if the number of retransmissions of the activation signal on the flexible RO is greater than or not less than a particular number.

In some embodiments, the terminal transmits the signal to the network-side device using the flexible resource switched from the normal resource when a third preset condition is satisfied. In other words, the terminal also supports switching from the normal resource to the flexible resource for signal transmission.

Optionally, the third preset condition includes at least one of the following:
a number of failed transmissions of the signal by the terminal on the normal resource is greater than or not less than a preset threshold;
the measurement metric of the reference signal corresponding to the normal resource does not meet preset requirements;
a number of transmitting repetitions of the signal by the terminal on the normal resource is greater than or not less than a preset threshold; or
For example, when the normal resource is a normal RO, the terminal switches from the normal RO to a flexible RO for PRACH transmission if the number of failed transmissions on the normal RO is greater than or not less than a preset value, such as a particular number. For another example, the terminal switches from the normal RO to a flexible RO for PRACH transmission if the terminal measures that the signal strength (e.g., RSRP) or quality (e.g., RSRQ) of a reference signal associated with the normal RO, such as an SSB, or a function thereof, fails to meet a particular requirement. For another example, the terminal switches from the normal RO to a flexible RO for PRACH transmission after attempting for a maximum or particular number of PRACH repetitions on the normal RO.

In other words, the terminal supports switching from a flexible RO to a normal RO, and also supports switching from a normal RO to a flexible RO. For example, the terminal switches to a second RO if the number of failed (PRACH) transmissions on a first RO is greater than or not less than a particular number. For another example, the terminal switches to the second RO for PRACH transmission if the measured signal strength, quality, or function of a reference signal associated with the first RO fails to meet a particular requirement. For another example, the terminal may switch to the second RO for PRACH transmission after attempting for a maximum or particular number of PRACH repetitions on the first RO. The first RO is a flexible RO and the second RO is a normal RO. Alternatively, the first RO is a normal RO and the second RO is a flexible RO.

Optionally, if the terminal keeps attempting PRACH transmission on a first resource (e.g., an RO), the terminal may be allowed to switch to a second resource (e.g., an RO) to continue attempting PRACH transmission when the second preset condition or the third preset condition is satisfied. In other words, the terminal is not allowed to switch back to a previously attempted resource type for signal transmission. For example, if the terminal keeps attempting PRACH transmission on a flexible RO and the second preset condition is satisfied, the terminal may be allowed to switch to a normal RO to continue PRACH transmission. If the terminal continues attempting PRACH transmission on the normal RO and the third preset condition is satisfied, the terminal is not allowed to switch to the flexible RO for PRACH transmission since the terminal has previously attempted PRACH transmission on the flexible RO without success. By configuring the terminal not to switch to a previously attempted resource type, the terminal can be prevented from switching back to a previously attempted resource that cannot support signal transmission, thereby contributing to improving the reliability of signal transmission.

Therefore, by selecting to perform signal transmission on the flexible resource or the normal resource under appropriate conditions, the terminal can be ensured to select an appropriate resource for signal transmission, reduce resource conflicts between the terminal and other terminals, and improve the probability of successful signal reception.

In some embodiments, an occasion for using the flexible resource includes at least one of the following:
after the terminal transmits the activation signal;
after a first time interval after the terminal transmits the activation signal;
before a second time interval after the terminal transmits the activation signal;
after time at which the feedback signal in response to the activation signal transmitted by the network-side device is received;
after a third time interval following time at which the feedback signal in response to the activation signal transmitted by the network-side device is received;
before the terminal transmits the deactivation signal;
before a fourth time interval after the terminal transmits the deactivation signal;
before time at which the feedback signal in response to the deactivation signal transmitted by the network-side device is received; or
before a fifth time interval following time at which the feedback signal in response to the deactivation signal transmitted by the network-side device is received.

Optionally, the first time interval may be configured by a network or specified by a protocol. Optionally, the first time interval may be determined based on an uplink signal processing time.

Optionally, the second time interval may be configured by a network or specified by a protocol. When the occasion for using the flexible resource includes: before a second time interval after the terminal transmits the activation signal, the activated flexible resource is automatically deactivated after the second time interval from the activation moment.

Optionally, the third time interval may be configured by a network or specified by a protocol. Optionally, the third time interval may be determined according to at least one of an uplink signal processing time or a downlink signal receiving and processing time.

Optionally, the fourth time interval may be configured by a network or specified by a protocol. Optionally, the fourth time interval may be determined according to an uplink signal processing time.

Optionally, the fifth time interval may be configured by a network or specified by a protocol. Optionally, the fifth time interval may be determined according to at least one of an uplink signal processing time or a downlink signal receiving and processing time.

Therefore, by determining the occasion for using the flexible resource, the embodiments of this application can contribute to ensuring that the terminal and the network-side device reach a consensus on the effective time of the flexible resource, avoiding blind signal transmitting on the flexible resource by the terminal or blind signal receiving on the flexible resource by the network-side device, and improving the reliability of signal transmission.

The communication method according to the embodiments of this application may be performed by a communication apparatus. In the embodiments of this application, the communication apparatus according to the embodiments of this application is illustrated in an example where the communication apparatus performs the communication method.

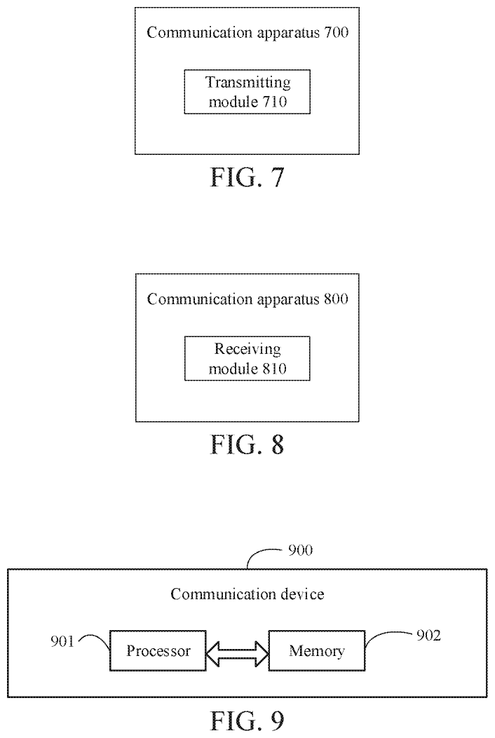

FIG. 7 shows a schematic block diagram of a communication apparatus 700 according to an embodiment of this application. The communication apparatus 700 may perform the steps performed by a terminal in the communication method 500. As shown in FIG. 7, the communication apparatus 700 includes a transmitting module 710.

The transmitting module 710 is configured to transmit an activation signal or a deactivation signal to a network-side device. The activation signal is used for requesting or notifying the network-side device to activate a flexible resource for signal transmission. The deactivation signal is used for requesting or notifying the network-side device to deactivate the flexible resource.

In some embodiments, the transmitting module 710 is further configured to perform at least one of the following operations:
retransmitting the activation signal when a number of failed signal transmissions on the flexible resource exceeds or is not less than a first preset number;
retransmitting, by the terminal, the deactivation signal when the terminal receives a response message for a signal transmitted on the flexible resource; or
retransmitting, by the terminal, the deactivation signal when the terminal receives a response message for a signal transmitted on the flexible resource and a number of receptions of the response message exceeds a second preset number.

In some embodiments, the communication apparatus 700 further includes a determining module, configured to:
determine that the signal transmission fails when a maximum number of retransmissions of the activation signal or the deactivation signal is reached.

In some embodiments, the transmitting module 710 is specifically configured to:
retransmit the activation signal within a first time window or before a first timer expires.

In some embodiments, the transmitting module 710 is specifically configured to:
retransmit the deactivation signal within a second time window or before a second timer expires.

In some embodiments, the communication apparatus 700 further includes a receiving module, configured to:
receive a feedback signal in response to the activation signal or the deactivation signal.

In some embodiments, the feedback signal is used for indicating one or more of the following:
whether the activation signal or the deactivation signal is successfully received;
whether the network-side device activates or deactivates the flexible resource; or
time at which the network-side device activates or deactivates the flexible resource.

In some embodiments, the receiving module is specifically configured to:
receive, by the terminal, a specific reference signal from the network-side device;
receive, by the terminal, a response message from the network-side device; or
receive, by the terminal, physical layer signaling from the network-side device.

In some embodiments, the specific reference signal includes an on-demand reference signal. The on-demand reference signal is used for indicating that the activation signal is successfully received, or indicating that the network-side device activates the flexible resource, or indicating time at which the network-side device activates or deactivates the flexible resource.

In some embodiments, the determining module is further configured to:
determine that the deactivation signal is successfully received, or determine that the network-side device deactivates the flexible resource, when the terminal does not receive the specific reference signal.

In some embodiments, the determining module is further configured to perform one or more of the following operations:
determining that the activation signal is successfully received, or determining that the network-side device activates the flexible resource, when the terminal identifies the response message according to a preset first RNTI; or
determining that the deactivation signal is successfully received, or determining that the network-side device deactivates the flexible resource, when the terminal identifies the response message according to a preset second RNTI.

In some embodiments, the receiving module is specifically configured to perform at least one of the following operations:
receiving a first physical downlink control channel (PDCCH) order from the network-side device, the first PDCCH order being used for indicating that the signal is transmitted using the flexible resource, or indicating that the network-side device activates the flexible resource, or indicate time at which the network-side device activates the flexible resource; or
receiving a second PDCCH order from the network-side device, the second PDCCH order being used for indicating that the signal is transmitted using a normal resource, or indicating that the network-side device deactivates the flexible resource, or indicate time at which the network-side device deactivates the flexible resource.

In some embodiments, the receiving module is specifically configured to perform at least one of the following operations:
receiving a third PDCCH order from the network-side device, the third PDCCH order including a first preamble identifier (ID), and the first preamble ID being used for indicating that the activation signal is successfully received, or indicating that the network-side device activates the flexible resource; or
receiving a fourth PDCCH order from the network-side device, the fourth PDCCH order including a second preamble identifier (ID), and the second preamble ID being used for indicating that the deactivation signal is successfully received, or indicating that the network-side device deactivates the flexible resource.

In some embodiments, the receiving module is specifically configured to perform at least one of the following operations:
receiving a first common PDCCH from the network-side device, the first common PDCCH being of a first DCI format, for indicating that the activation signal is successfully received, or that the network-side device activates the flexible resource; or
receiving a second common PDCCH from the network-side device, the second common PDCCH being of a second DCI format, for indicating that the deactivation signal is successfully received, or that the network-side device deactivates the flexible resource.

In some embodiments, the receiving module is specifically configured to:
receive the feedback signal within a third time window.

In some embodiments, a starting position of the third time window includes a first time for receiving a downlink signal after transmitting the activation signal or the deactivation signal.

In some embodiments, a length of the third time window is N times a length of a random access response (RAR) window, N being a positive integer, where N is configured by the network-side device or specified by a protocol.

In some embodiments, the transmitting module 710 is further configured to:
retransmit the activation signal or the deactivation signal if the terminal does not receive the feedback signal within the third time window.

In some embodiments, the transmitting module 710 is further configured to:
retransmit, by the terminal, the activation signal or the deactivation signal at a first time after the third time window expires.

In some embodiments, the transmitting module 710 is further configured to:
transmit the signal to the network-side device using the flexible resource when the terminal determines that the flexible resource has been activated.

In some embodiments, the transmitting module 710 is further configured to:
transmit the signal to the network-side device using the flexible resource within a preset time range.

In some embodiments, the preset time range includes at least one resource configuration cycle.

In some embodiments, the transmitting module 710 is further configured to:
transmit the signal using a first nearest available resource in a next time period when the terminal does not receive a response message to the signal.

In some embodiments, the transmitting module 710 is further configured to:
transmit, by the terminal, the signal to the network-side device using the flexible resource for initial transmission of the signal.

In some embodiments, the initial transmission includes at least one of the following:
initial transmission without power ramping;
initial transmission including repetitions; or
initial transmission not including repetitions.

In some embodiments, the transmitting module 710 is further configured to:
transmit the signal to the network-side device using the flexible resource when a first measurement metric of a reference signal corresponding to the flexible resource satisfies a first preset condition.

In some embodiments, the first preset condition includes at least one of the following:
the first measurement metric is greater than or not less than a second measurement metric of a reference signal corresponding to a common time-frequency resource; or
the first measurement metric is greater than or not less than a preset threshold.

In some embodiments, the transmitting module 710 is further configured to:
transmit the signal to the network-side device using a normal resource switched from the flexible resource when a second preset condition is satisfied.

In some embodiments, the second preset condition includes at least one of the following:
a number of failed transmissions of the signal by the terminal on the flexible resource is greater than or not less than a preset threshold;
the measurement metric of the reference signal corresponding to the flexible resource does not meet preset requirements;
a number of repetitions of signal transmission by the terminal on the flexible resource is greater than or not less than a preset threshold; or
a number of retransmissions of the activation signal is greater than or not less than a preset threshold.

In some embodiments, an occasion for using the flexible resource includes at least one of the following:
after the terminal transmits the activation signal;
after a first time interval after the terminal transmits the activation signal;
before a second time interval after the terminal transmits the activation signal;
after time at which the feedback signal in response to the activation signal transmitted by the network-side device is received;
after a third time interval following time at which the feedback signal in response to the activation signal transmitted by the network-side device is received;
before the terminal transmits the deactivation signal;
before a fourth time interval after the terminal transmits the deactivation signal;
before time at which the feedback signal in response to the deactivation signal transmitted by the network-side device is received; or
before a fifth time interval following time at which the feedback signal in response to the deactivation signal transmitted by the network-side device is received.

In some embodiments, the flexible resource includes at least one of a flexible PRACH transmission occasion, a flexible PUSCH transmission occasion, a flexible paging occasion, a flexible PDSCH transmission occasion, a flexible PDCCH transmission occasion, or a flexible MsgA PUSCH transmission occasion.

The communication apparatus 700 in the embodiments of this application may be an electronic device, such as an electronic device having an operating system, or a component in an electronic device, such as an integrated circuit or a chip. The electronic device may be a terminal, or may be another device other than a terminal. For example, the terminal may include, but is not limited to, types of the terminal 11 listed above. The another device may be a server, a network attached storage (Network Attached Storage, NAS), or the like. This is not specifically limited in the embodiments of this application.

The communication apparatus 700 according to the embodiments of this application can implement each process implemented by the terminal in the method embodiments of FIG. 5 to FIG. 6, and achieve the same technical effect. To avoid repetition, details are not described herein.

FIG. 8 shows a schematic block diagram of another communication apparatus 800 according to an embodiment of this application. The communication apparatus 800 may perform the steps performed by a network-side device in the communication method 500. As shown in FIG. 8, the communication apparatus 800 includes a receiving module 810.

The receiving module 810 is configured to receive an activation signal or a deactivation signal from a terminal. The activation signal is used for requesting or notifying the network-side device to activate a flexible resource for signal transmission. The deactivation signal is used for requesting or notifying the network-side device to deactivate the flexible resource.

In some embodiments, the communication apparatus 800 further includes a transmitting module, configured to:
transmit a feedback signal in response to the activation signal or the deactivation signal to the terminal.

In some embodiments, the feedback signal is used for indicating one or more of the following:
whether the activation signal or the deactivation signal is successfully received;
whether the network-side device activates or deactivates the flexible resource; or
time at which the network-side device activates or deactivates the flexible resource.

In some embodiments, the transmitting module is specifically configured to perform one or more of the following operations:
transmitting a specific reference signal to the terminal;
transmitting a response message to the terminal; or
transmitting physical layer signaling to the terminal.

In some embodiments, the specific reference signal includes an on-demand reference signal. The on-demand reference signal is used for indicating that the activation signal is successfully received, or indicating that the network-side device activates the flexible resource, or indicating time at which the network-side device activates or deactivates the flexible resource.

In some embodiments, the transmitting module is specifically configured to perform one or more of the following operations:
transmitting, by the network-side device, a first physical downlink control channel (PDCCH) order to the terminal, the first PDCCH order being used for indicating that the signal is transmitted using the flexible resource, or indicating that the network-side device activates the flexible resource, or indicate time at which the network-side device activates the flexible resource; or
transmitting, by the network-side device, a second PDCCH order to the terminal, the second PDCCH order being used for indicating that the signal is transmitted using a normal resource, or indicating that the network-side device deactivates the flexible resource, or indicate time at which the network-side device deactivates the flexible resource.

In some embodiments, the transmitting module is specifically configured to perform one or more of the following operations:
transmitting, by the network-side device, a third PDCCH order to the terminal, the third PDCCH order including a first preamble identifier (ID), and the first preamble ID being used for indicating that the activation signal is successfully received, or indicating that the network-side device activates the flexible resource; or
transmitting, by the network-side device, a fourth PDCCH order to the terminal, the fourth PDCCH order including a second preamble identifier (ID), and the second preamble ID being used for indicating that the deactivation signal is successfully received, or indicating that the network-side device deactivates the flexible resource.

In some embodiments, the transmitting module is specifically configured to perform one or more of the following operations:
transmitting, by the network-side device, a first common PDCCH, the first common PDCCH being of a first DCI format, for indicating that the activation signal is successfully received, or that the network-side device activates the flexible resource; or
transmitting, by the network-side device, a second common PDCCH, the second common PDCCH being of a second DCI format, for indicating that the deactivation signal is successfully received, or that the network-side device deactivates the flexible resource.

In some embodiments, an occasion for using the flexible resource includes at least one of the following:
after the terminal transmits the activation signal;
after a first time interval after the terminal transmits the activation signal;
before a second time interval after the terminal transmits the activation signal;
after time at which the feedback signal in response to the activation signal transmitted by the network-side device is received;
after a third time interval following time at which the feedback signal in response to the activation signal transmitted by the network-side device is received;
before the terminal transmits the deactivation signal;
before a fourth time interval after the terminal transmits the deactivation signal;
before time at which the feedback signal in response to the deactivation signal transmitted by the network-side device is received; or
before a fifth time interval following time at which the feedback signal in response to the deactivation signal transmitted by the network-side device is received.

In some embodiments, the flexible resource includes at least one of a flexible PRACH transmission occasion, a flexible PUSCH transmission occasion, a flexible paging occasion, a flexible PDSCH transmission occasion, a flexible PDCCH transmission occasion, or a flexible MsgA PUSCH transmission occasion.

The communication apparatus in the embodiments of this application may be an electronic device, for example, an electronic device having an operating system, or a component in an electronic device, such as an integrated circuit or a chip. The electronic device may be a network-side device, or may be another device other than a network-side device. For example, the network-side device may include, but is not limited to, types of the network-side device 12 listed above. The another device may be a server, a network attached storage (Network Attached Storage, NAS), or the like. This is not specifically limited in the embodiments of this application.

The communication apparatus 800 according to the embodiments of this application can implement each process implemented by the network-side device in the method embodiments of FIG. 5 to FIG. 6, and achieve the same technical effect. To avoid repetition, details are not described herein.

As shown in FIG. 9, embodiments of this application further provide a communication device 900, including a processor 901 and a memory 902. The memory 902 has a program or instructions executable in the processor 901 stored therein. For example, when the communication device 900 is a terminal, the program or instructions, when executed by the processor 901, implement steps performed by the terminal in the embodiments of the communication method 500 and can achieve the same technical effect. When the communication device 900 is a network-side device, the program or instructions, when executed by the processor 901, implement steps performed by the network-side device in the embodiments of the communication method 500 and can achieve the same technical effect. To avoid repetition, details are not described herein.

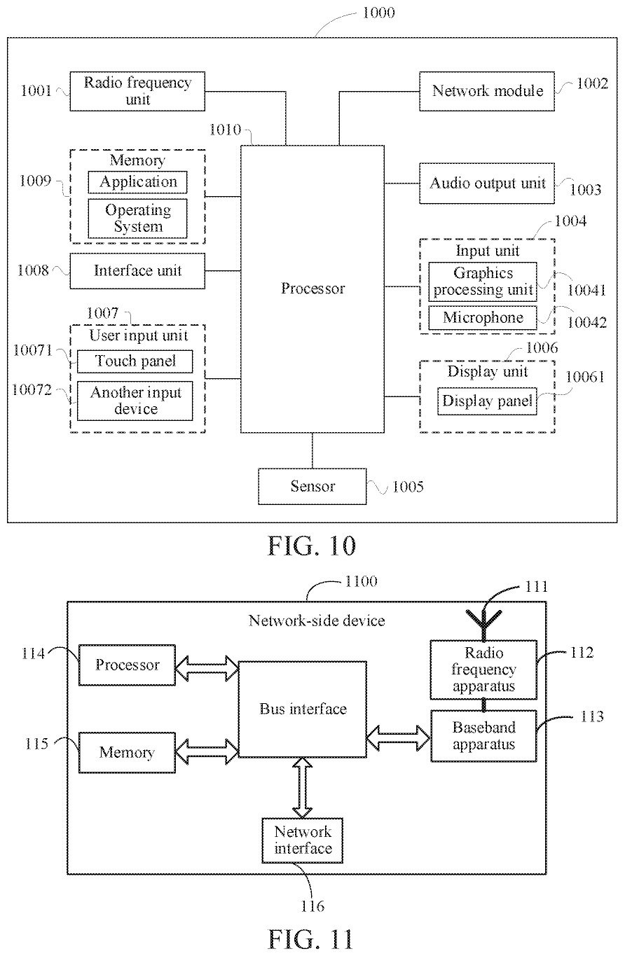

Embodiments of this application further provide a terminal, including a processor and a communication interface. The communication interface is coupled to the processor. The processor is configured to execute a program or instructions, to implement steps performed by the terminal in the method embodiments shown in FIG. 5 to FIG. 6. The terminal embodiments correspond to the foregoing method embodiments on a terminal side. Implementation processes and implementations of the terminal in the foregoing method embodiments may be applied to the terminal embodiments and can achieve the same technical effect. Specifically, FIG. 10 is a schematic diagram of a hardware structure of a terminal for implementing an embodiment of this application.

The terminal 1000 includes, but is not limited to, at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (e.g., a battery) that supplies power to the components. The power supply may be logically connected to the processor 1010 by using a power management system, thereby implementing functions such as management of charging, discharging, and power consumption by using the power management system. The terminal structure shown in FIG. 10 constitutes no limitation on the terminal. The terminal may include more or fewer components than those shown in the figure, or some merged components, or different component arrangements. Details are not described herein again.

It will be understood that in the embodiments of this application, the input unit 1004 may include a graphics processing unit (Graphics Processing Unit, GPU) 10041 and a microphone 10042. The graphics processing unit 10041 processes image data of a static picture or a video obtained by an image capture apparatus (e.g., a camera) in a video capture mode or an image capture mode. The display unit 1006 may include a display panel 10061. The display panel 10061 may be configured by using a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include, but is not limited to, a physical keyboard, a functional key (e.g., a volume control key or a switch key), a track ball, a mouse, and a joystick. Details are not described herein again.

In the embodiments of this application, the radio frequency unit 1001 receives downlink data from a network-side device and may transmit the data to the processor 1010 for processing. In addition, the radio frequency unit 1001 may transmit uplink data to the network-side device. Generally, the radio frequency unit 1001 includes, but is not limited to, an antenna, an amplifier, a transceiver, a coupler, a low noise amplifier, a duplexer, and the like.

The memory 1009 may be configured to store a software program or instructions and various data. The memory 1009 may mainly include a first storage region for storing a program or instructions and a second storage region for storing data. The first storage region may store an operating system, an application or instructions required by at least one function (e.g., a sound playback function and an image playback function), or the like. In addition, the memory 1009 may include a volatile memory or non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus dynamic random access memory (Direct Rambus RAM, DRRAM). The memory 1009 in the embodiments of this application includes, but is not limited to, these memories and any other suitable types of memories.

The processor 1010 may include one or more processing units. Optionally, the processor 1010 integrates an application processor and a modem processor, where the application processor mainly processes operations involving an operating system, a user interface, an application, or the like, and the modem processor mainly processes a wireless communication signal, such as a baseband processor. It may be understood that, alternatively, the modem processor may not be integrated into the processor 1010.

The radio frequency unit 1001 is configured to transmit an activation signal or a deactivation signal to a network-side device. The activation signal is used for requesting or notifying the network-side device to activate a flexible resource for signal transmission. The deactivation signal is used for requesting or notifying the network-side device to deactivate the flexible resource.

In the embodiments of this application, by transmitting the activation or deactivation signal to the network-side device, the terminal can trigger activation or deactivation of the flexible resource, so that the flexible resource is activated only when required and not activated (deactivated) when not required. Therefore, signal detection on the flexible resource is not required in a case that the flexible resource is inactive, thereby contributing to reducing the complexity and power consumption of signal detection. Meanwhile, the flexible resource may further be used for scheduling other uplink or downlink transmissions, thereby contributing to improving resource utilization.

It may be understood that, for implementation processes of various implementations mentioned in this embodiment, refer to related descriptions in method embodiments, and the same or corresponding technical effects are achieved. To avoid repetition, details are not described herein again.

Embodiments of this application further provide a network-side device, including a processor and a communication interface. The communication interface is coupled to the processor. The processor is configured to execute a program or instructions, to implement steps performed by the network-side device in the method embodiments shown in FIG. 5 to FIG. 6. The network-side device embodiments correspond to the foregoing method embodiments on a network-side device side. Implementation processes and implementations of the network-side device in the foregoing method embodiments may be applied to the network-side device embodiments and can achieve the same technical effect.

Specifically, embodiments of this application further provide a network-side device. As shown in FIG. 11, the network-side device 1100 includes: an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and transmits the received information to the baseband apparatus 113 for processing. In a downlink direction, the baseband apparatus 113 processes information to be transmitted, and transmits the information to the radio frequency apparatus 112. The radio frequency apparatus 112 processes the received information, and transmits the information via the antenna 111.

The method performed by the network-side device in the foregoing embodiments may be implemented in the baseband apparatus 113. The baseband apparatus 113 includes a baseband processor.

The baseband apparatus 113 may include, for example, at least one baseband board. A plurality of chips are disposed on the baseband board. As shown in FIG. 11, one of the chips is, for example, the baseband processor, which is connected to the memory 115 through a bus interface to invoke a program in the memory 115 to perform the network device operations shown in the foregoing method embodiments.

The network-side device may further include a network interface 116. The interface is, for example, a common public radio interface (Common Public Radio Interface, CPRI).

Specifically, the network-side device 1100 according to the embodiments of this application further includes: instructions or a program stored in the memory 115 and executable on the processor 114. The processor 114 invokes the instructions or program in the memory 115 to perform the method performed by the module shown in FIG. 8, and the same technical effect is achieved. To avoid repetition, details are not described herein again.

Embodiments of this application further provide a readable storage medium. The readable storage medium has a program or instructions stored therein. The program or instructions, when executed by a processor, implement the processes performed by the terminal in the foregoing communication method embodiments or the processes performed by the network-side device, and can achieve the same technical effect. To avoid repetition, details are not described herein again.

The processor is the processor in the terminal described in the foregoing embodiments or the processor in the network-side device. The readable storage medium includes a computer-readable storage medium, such as a computer read-only memory (ROM), a random access memory (RAM), a magnetic disk, or an optical disc. In some examples, the readable storage medium may be a non-transient readable storage medium.

Embodiments of this application additionally provide a chip. The chip includes a processor and a communication interface. The communication interface is coupled to the processor. The processor is configured to execute a program or instructions, to implement the processes performed by the terminal in the foregoing communication method embodiments or the processes performed by the network, and can achieve the same technical effect. To avoid repetition, details are not described herein again.

It should be understood that the chip mentioned in the embodiments of this application may alternatively be referred to as a system-on-chip, a system chip, a chip system, a system on chip, or the like.

Embodiments of this application additionally provide a computer program/program product. The computer program/program product is stored in a storage medium. The computer program/program product, when executed by at least one processor, implements the processes performed by the terminal in the foregoing communication method embodiments or the processes performed by the network, and can achieve the same technical effect. To avoid repetition, details are not described herein again.

Embodiments of this application further provide a communication system, including a terminal and a network-side device. The terminal may be configured to perform the steps performed by the terminal in the communication method described above. The network-side device may be configured to perform the steps performed by the network-side device in the communication method described above.

It should be noted that the terms “include”, “comprise”, or any other variation thereof herein is intended to cover a non-exclusive inclusion, so that a process, method, article, or apparatus including a series of elements not only includes those elements but also includes other elements which are not clearly listed or further includes intrinsic elements of the process, method, article, or apparatus. Without more limitations, an element defined by a sentence “including a . . . ” does not exclude a case that there are still other same elements in the process, method, object, or apparatus including the element. In addition, it should be noted that the scope of the method and the apparatus in implementations of this application is not limited to function execution in the order shown or discussed, and may further include function execution in a substantially simultaneous manner or in the opposite order based on the functions. For example, the described method may be performed in different order from the described order, and various steps may further be added, omitted, or combined. In addition, features described with reference to some examples may be combined in other examples.

Through the description of the foregoing implementations, a person skilled in the art may clearly understand that the methods according to the foregoing embodiments may be implemented by a computer software product and a necessary general hardware platform, and certainly, may alternatively be implemented by hardware. The computer software product is stored in a storage medium (e.g., a ROM, a RAM, a magnetic disk, or an optical disc) and includes several instructions for instructing a terminal or a network-side device to perform the methods described in the embodiments of this application.

Embodiments of this application are described above with reference to the accompanying drawings. However, this application is not limited to the foregoing specific implementations, and the foregoing specific implementations are only illustrative and not restrictive. A person of ordinary skill in the art may make implementations in many forms under the teaching of this application without departing from the spirit of this application and the protection scope of the claims. These implementations fall within the protection scope of this application.

What is claimed is:

1. A communication method, comprising:
transmitting, by a terminal, an activation signal or a deactivation signal to a network-side device, the activation signal being used for requesting or notifying the network-side device to activate a flexible resource for signal transmission, and the deactivation signal being used for requesting or notifying the network-side device to deactivate the flexible resource.

2. The method according to claim 1, further comprising one or more of the following:
retransmitting, by the terminal, the activation signal when a number of failed signal transmissions on the flexible resource exceeds or is not less than a first preset number;
retransmitting, by the terminal, the deactivation signal when the terminal receives a response message for a signal transmitted on the flexible resource; or
retransmitting, by the terminal, the deactivation signal when the terminal receives the response message for the signal transmitted on the flexible resource and a number of receptions of the response message exceeds a second preset number.

3. The method according to claim 2, further comprising:
determining that the signal transmission fails when a maximum number of retransmissions of the activation signal or the deactivation signal is reached.

4. The method according to claim 2, wherein the retransmitting, by the terminal, the activation signal comprises:
retransmitting, by the terminal, the activation signal within a first time window or before a first timer expires, or
wherein the retransmitting, by the terminal, the deactivation signal comprises:
retransmitting, by the terminal, the deactivation signal within a second time window or before a second timer expires.

5. The method according to claim 1, further comprising:
receiving, by the terminal, a feedback signal in response to the activation signal or the deactivation signal,
wherein the feedback signal is used for indicating one or more of the following:
whether the activation signal or the deactivation signal is successfully received;
whether the network-side device activates or deactivates the flexible resource; or
time at which the network-side device activates or deactivates the flexible resource.

6. The method according to claim 5, wherein the receiving, by the terminal, the feedback signal in response to the activation signal or the deactivation signal comprises one or more of the following:
receiving, by the terminal, a specific reference signal from the network-side device;
receiving, by the terminal, a response message from the network-side device; or
receiving, by the terminal, physical layer signaling from the network-side device.

7. The method according to claim 6, further comprising one or more of the following:
determining, by the terminal, that the activation signal is successfully received, or determining that the network-side device activates the flexible resource, when the terminal identifies the response message according to a preset first radio network temporary identifier (RNTI); or
determining, by the terminal, that the deactivation signal is successfully received, or determining that the network-side device deactivates the flexible resource, when the terminal identifies the response message according to a preset second RNTI.

8. The method according to claim 6, wherein the receiving, by the terminal, the physical layer signaling from the network-side device comprises one or more of the following:
receiving, by the terminal, a first physical downlink control channel (PDCCH) order from the network-side device, the first PDCCH order being used for indicating that the signal is transmitted using the flexible resource, or indicating that the network-side device activates the flexible resource, or indicate time at which the network-side device activates the flexible resource; or
receiving, by the terminal, a second PDCCH order from the network-side device, the second PDCCH order being used for indicating that the signal is transmitted using a normal resource, or indicating that the network-side device deactivates the flexible resource, or indicate time at which the network-side device deactivates the flexible resource, or
wherein the receiving, by the terminal, the physical layer signaling from the network-side device comprises one or more of the following:
receiving, by the terminal, a third PDCCH order from the network-side device, the third PDCCH order comprising a first preamble identifier (ID), and the first preamble ID being used for indicating that the activation signal is successfully received, or indicating that the network-side device activates the flexible resource; or
receiving, by the terminal, a fourth PDCCH order from the network-side device, the fourth PDCCH order comprising a second preamble identifier (ID), and the second preamble ID being used for indicating that the deactivation signal is successfully received, or indicating that the network-side device deactivates the flexible resource, or
wherein the receiving, by the terminal, physical layer signaling from the network-side device comprises:
receiving, by the terminal, a first common PDCCH from the network-side device, the first common PDCCH being of a first DCI format, for indicating that the activation signal is successfully received, or that the network-side device activates the flexible resource; or
receiving, by the terminal, a second common PDCCH from the network-side device, the second common PDCCH being of a second DCI format, for indicating that the deactivation signal is successfully received, or that the network-side device deactivates the flexible resource.

9. The method according to claim 5, wherein the receiving, by the terminal, the feedback signal from the network-side device comprises:
receiving, by the terminal, the feedback signal within a third time window,
wherein a starting position of the third time window comprises a first time for receiving a downlink signal after transmitting the activation signal or the deactivation signal.

10. The method according to claim 9, wherein a length of the third time window is N times a length of a random access response (RAR) window, N being a positive integer, and N being configured by the network-side device or specified by a protocol.

11. The method according to claim 9, further comprising:
retransmitting, by the terminal, the activation signal or the deactivation signal if the terminal does not receive the feedback signal within the third time window,
wherein the retransmitting, by the terminal, the activation signal or the deactivation signal comprises:
retransmitting, by the terminal, the activation signal or the deactivation signal at a first time after the third time window expires.

12. The method according to claim 11, wherein an occasion for using the flexible resource comprises at least one of the following:
after the terminal transmits the activation signal;
after a first time interval after the terminal transmits the activation signal;
before a second time interval after the terminal transmits the activation signal;
after time at which the feedback signal in response to the activation signal transmitted by the network-side device is received;
after a third time interval following time at which the feedback signal in response to the activation signal transmitted by the network-side device is received;
before the terminal transmits the deactivation signal;
before a fourth time interval after the terminal transmits the deactivation signal;
before time at which the feedback signal in response to the deactivation signal transmitted by the network-side device is received; or
before a fifth time interval following time at which the feedback signal in response to the deactivation signal transmitted by the network-side device is received.

13. The method according to claim 1, further comprising:
transmitting, by the terminal, the signal to the network-side device using the flexible resource when the terminal determines that the flexible resource has been activated, or
transmitting, by the terminal, the signal to the network-side device using the flexible resource within a preset time range, wherein the preset time range comprises at least one resource configuration cycle.

14. The method according to claim 13, further comprising:
transmitting, by the terminal, the signal using a first nearest available resource in a next time period when the terminal does not receive a response message to the signal.

15. The method according to claim 13, further comprising:
transmitting, by the terminal, the signal to the network-side device using a normal resource switched from the flexible resource when a second preset condition is satisfied,
wherein the second preset condition comprises at least one of the following:
a number of failed transmissions of the signal by the terminal on the flexible resource is greater than or not less than a preset threshold;
a measurement metric of a reference signal corresponding to the flexible resource does not meet preset requirements;
a number of repetitions of signal transmission by the terminal on the flexible resource is greater than or not less than the preset threshold; or
a number of retransmissions of the activation signal is greater than or not less than the preset threshold.

16. The method according to claim 1, further comprising:
transmitting, by the terminal, the signal to the network-side device using the flexible resource for initial transmission of the signal,
wherein the initial transmission comprises at least one of the following:
initial transmission without power ramping;
initial transmission comprising repetitions; or
initial transmission not comprising repetitions.

17. The method according to claim 1, further comprising:
transmitting, by the terminal, the signal to the network-side device using the flexible resource when a first measurement metric of a reference signal corresponding to the flexible resource satisfies a first preset condition,
wherein the first preset condition comprises at least one of the following:
the first measurement metric is greater than or not less than a second measurement metric of a reference signal corresponding to a common time-frequency resource; or
the first measurement metric is greater than or not less than a preset threshold.

18. A communication method, comprising:
receiving, by a network-side device, an activation signal or a deactivation signal from a terminal, the activation signal being used for requesting or notifying the network-side device to activate a flexible resource for signal transmission, and the deactivation signal being used for requesting or notifying the network-side device to deactivate the flexible resource.

19. A network-side device, comprising a processor and a memory, wherein the memory stores a program or instructions executable in the processor, and the program or instructions, when executed by the processor, implement the steps of the communication method according to claim 18.

20. A terminal, comprising a processor and a memory, wherein the memory stores a program or instructions executable in the processor, and the program or the instructions, when executed by the processor, cause the terminal to:
transmit an activation signal or a deactivation signal to a network-side device, the activation signal being used for requesting or notifying the network-side device to activate a flexible resource for signal transmission, and the deactivation signal being used for requesting or notifying the network-side device to deactivate the flexible resource.
